(19) United States
(12) Patent Application Publication
(10) Pub. No.: US 2003/0173791 A1
(43) Pub. Date: Sep. 18, 2003

(54) Lifting device

(76) Inventor: Gerhard Geis, Hosbach (DE)

Correspondence Address: VENABLE, BAETJER, HOWARD AND CIVILETTI, LLP, P.O. BOX 34385, WASHINGTON, DC, 20043-9998, US

(21) Appl. No.: 10/257,835

(22) PCT Filed: Mar. 11, 2002
(86) PCT No.: PCT/EP02/02643

(30) Foreign Application Priority Data
Mar. 14, 2001 (DE) 101 12 111.3

(51) Int. Cl. B66C 1/66

(52) U.S. Cl. 294/81.21; 294/81.53

(57) ABSTRACT

The invention relates to a lifting apparatus (1) for transporting a load carrier, having a main frame (2) and two sliding carriers (3), with a sliding carrier (3) being seated so as to be displaced in the longitudinal direction of the main frame, ending at each long-side end of the main frame (2). The sliding carriers (3) are provided at their free long-side ends with receptacles for coupling to the load carrier. Stilt legs (10) are seated to pivot on the sliding carriers (3), each being able to pivot into a first end position, in which the receptacles on the sliding carriers (3) for coupling to a load carrier are exposed. The sliding carriers (3) [sic] can also be pivoted into a second end position, in which the stilt legs (10) project from the undersides of the sliding carriers (3), so the stilt legs (10) can be coupled to a load carrier by receptacles provided at their free ends.

### The invention relates to a lifting apparatus as defined in the preamble to claim 1.

Lifting apparatuses of this type serve in transporting load carriers, particularly containers, and are typically used in dock facilities.

These lifting apparatuses, also referred to as spreaders, have stationary main frames, in which two sliding carriers are guided. The sliding carriers end at an exit opening at a long-side end of the main frame, and can be displaced in the longitudinal direction of the frame.

Receptacles for coupling to the respective load carrier are disposed at the free long-side ends of the sliding carriers. A head piece is located at each free end of the sliding carrier. A twist lock that forms a receptacle is respectively disposed at the two ends of the head piece protruding beyond the sliding carrier. These head pieces serve in securing the lifting apparatus to the load carrier.

Corner guides are provided as further receptacles; they serve in positioning the lifting apparatus on the load carrier. The corner guides are located in the immediate vicinity of the twist locks.

If the load carriers are containers, the lifting apparatus is positioned above the container. The corner guides orient the sliding carriers precisely to allow the twist locks provided on the head piece of the sliding carrier to engage corresponding recesses on the top side of the container. After the twist locks have been fixed in the container recesses, the lifting apparatus can lift the container. The coupling of the lifting apparatus, especially the securing of the twist locks in the container recesses, is controlled mechanically, without any human intervention.

Problems occur with the known lifting apparatuses when the apparatus is supposed to transport load carriers in which the items to be transported protrude past the upper edge of the load carrier. An example of these load carriers is so-called flats, which are used to transport oversized machine parts or the like. A flat has a level base with a rectangular cross-section, on which the machine part lies. Four profiles extend upward and perpendicular from the corners of the flat. The profiles are structurally identical, and are permanently attached to the flat base. Their height is smaller than the height of the machine part lying on the flat base.

Thus, the sliding carrier cannot be placed directly onto the profiles with the twist locks.

A separate, oversized frame is used for transporting this type of flat with the lifting apparatus. The oversized frame has a horizontal base frame, which comprises profiles that form a horizontal rectangle. A receiving profile extends downward from the corners of the base frame. The receiving profiles extend vertically, and are structured identically.

The base frame of the oversized frame has receptacles at the tops of the corners, into which a respective twist lock of the sliding carrier is inserted and secured. The oversized frame mounted to the lifting apparatus in this manner is positioned with the lower ends of the receiving profiles onto the upper ends of the flat profiles, and secured to them. The receiving profiles are longer than the length by which the machine part protrudes past the top of the flat, so adequate clearance remains between the machine part and the sliding carrier.

A disadvantage of this is that the oversized frame must be assembled manually. Not only is this an extremely cost- and labor-intensive process, but it is also potentially dangerous for the operating personnel.

A further disadvantage is that the oversized frame represents a separate component that must be stored in a suitable storage space. This means that an undesired large storage capacity is required, on the one hand. On the other hand, it is a difficult logistical consideration to keep an oversized frame ready to be mounted to a lifting apparatus at short notice.

Finally, the oversized frame is very heavy. Transporting load carriers with an oversized frame mounted to the lifting apparatus entails a considerable expenditure of energy.

It is the object of the invention to embody a lifting apparatus of the type mentioned at the outset to permit a flexible, economical adaptation to load carriers of different designs.

The object is accomplished by the features of claim 1. The dependent claims describe advantageous embodiments and modifications of the invention.

The lifting device in accordance with the invention serves in transporting a load carrier. It has a main frame and two sliding carriers, each of which is seated at a long-side end of the main frame so as to be displaced in the longitudinal direction of the main frame. The free long-side ends of the sliding carriers are provided with receptacles for coupling to the load carrier. Stilt legs are pivotably seated on the sliding carriers. These stilt legs can be pivoted into a first end position. In this end position, the receptacles in the sliding carriers for coupling to a load carrier are exposed. The stilt legs can be pivoted into a second end position, in which they project beyond the undersides of the sliding carriers, so the legs can be coupled to a load carrier by receptacles provided at their free ends.

The lifting device of the invention can transport load carriers whose recesses are accessible for coupling the receptacles of the sliding carriers to the top sides of the load carriers, as well as load carriers whose loads extend past the load-carrier top sides, and are therefore not directly accessible for the receptacles of the sliding carriers of the lifting apparatus.

Containers are particularly the load carriers of the first described type. For receiving containers, the lifting apparatus is guided to the top side of the respective container, with the stilt legs being in the first end positions.

In these end positions, the longitudinal axes of the stilt legs preferably extend essentially parallel to the horizontal longitudinal axes of the sliding carriers. In any case, in the first end positions, the stilt legs are oriented such that the receptacles, particularly the twist locks, are exposed on the sliding carriers, and can be coupled and secured to the top side of the container.

If, in contrast, the lifting apparatus is intended to transport a flat whose base is carrying a machine part or the like that protrudes past the top side of the flat, the stilt legs on the lifting apparatus are pivoted into their second end position, and preferably project vertically from the underside of the sliding carrier.

The stilt legs are then positioned on and secured to the top sides of the flat profiles, after which the flat can be raised with the lifting apparatus.

The pivoting movement of the stilt legs is effected automatically with suitable drives, and requires no manual intervention. The stilt legs are also coupled automatically, without any personnel involvement.

The lower ends of the stilt legs are preferably each provided with a twist lock, which is set into a rotational movement by a drive of the lifting apparatus in order to secure the twist lock of the stilt leg in a recess of the load carrier.

In principle, separate drives can be provided for this in the lifting apparatus. Further drives can also be provided for driving the corner guides; these are preferably mounted to the lower ends of the stilt legs, and serve in positioning the legs.

As an alternative, the corner guides can be permanently connected to the respective stilt legs.

In a preferred embodiment of the invention, the pivotable stilt legs are each associated with a twist lock on the sliding carrier.

The association is determined such that, in the first pivoting positions, the twist locks are decoupled from their associated stilt legs. For coupling the lifting apparatus to a container, for example, the twist locks are secured to receptacles on the container, thereby being set into a rotational movement by drives.

In the second end positions, each stilt leg is coupled to the associated twist lock of the sliding carrier such that the rotational movement of the twist lock of the sliding carrier is transmitted to the twist lock of the stilt leg. For this purpose, a mechanical coupling device is provided, which essentially comprises a carrier claw and a drive rod. In the second end position of a stilt leg, the carrier claw is coupled to the associated twist lock of the sliding carrier such that the carrier claw rotates with the lock. The drive rod then transmits the rotational movement of the carrier claw to the twist lock of the respective stilt leg. Hence, no additional drives are necessary for actuating the twist locks of the stilt legs.

The stilt legs mounted to the lifting apparatus weigh far less than conventional oversized frames, because the base frame is omitted altogether in the lifting apparatus of the invention.

Because the stilt legs, when in their first end positions, do not prevent the lifting apparatus from being coupled to load carriers by means of receptacles on the sliding carrier, the stilt legs need not be detached from the lifting apparatus in these cases. The fact that the stilt legs remain permanently mounted to the lifting apparatus eliminates the cost of storing the stilt legs and transporting them to the lifting apparatus.

The invention is described in detail below in conjunction with the drawings. Shown are in:

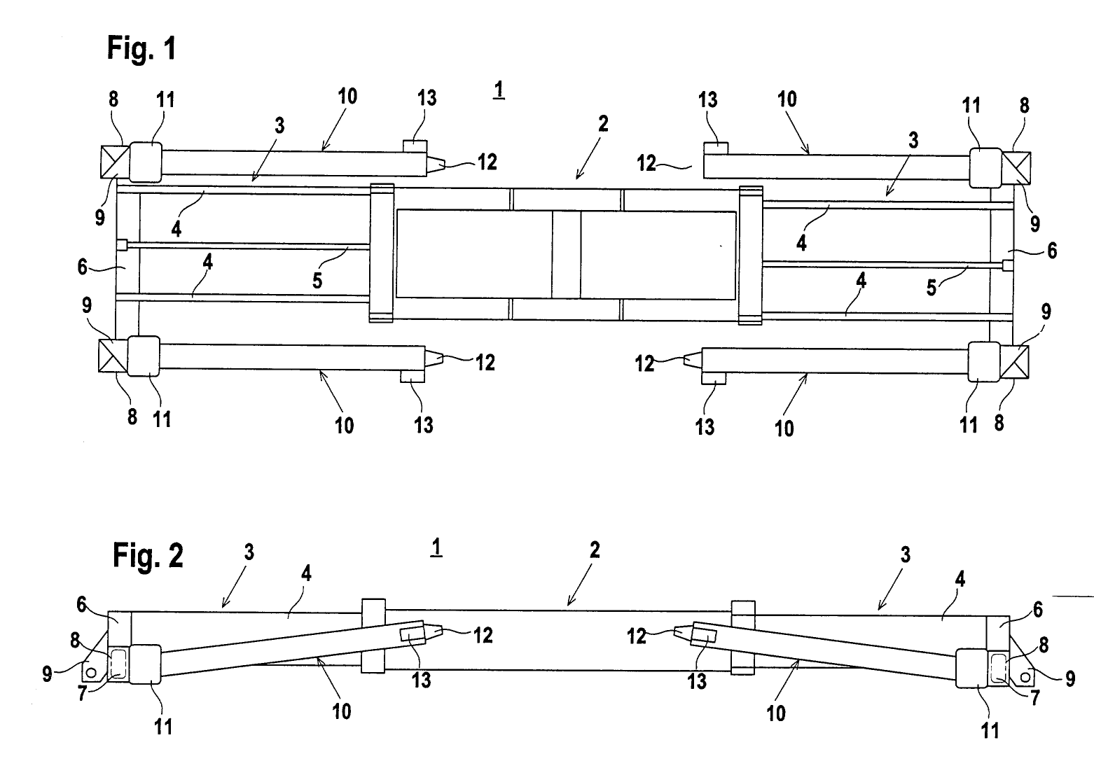

FIG. 1: a plan view of an exemplary embodiment of the lifting apparatus according to the invention, with stilt legs in the first end positions;

FIG. 2: a side view of the lifting apparatus according to FIG. 1;

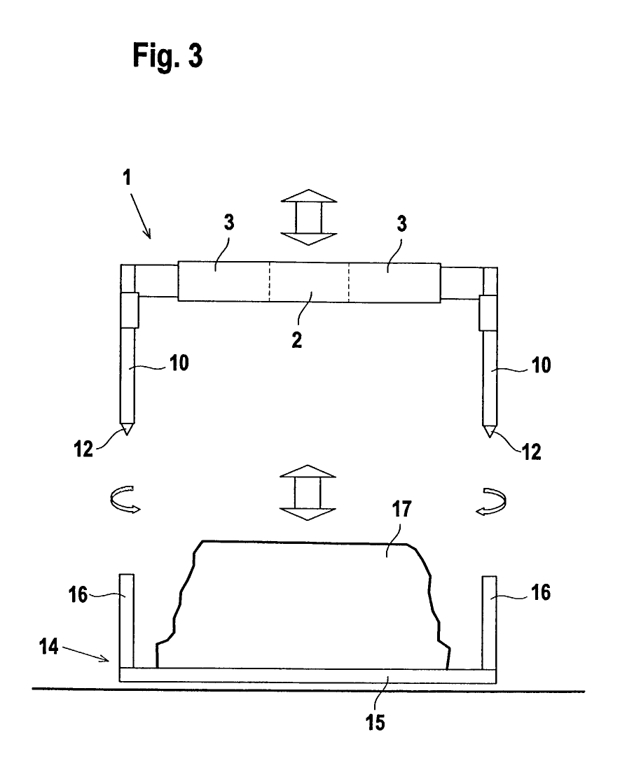

FIG. 3: a schematic representation of the lifting apparatus according to FIGS. 1 and 2, with the stilt legs being in their second end positions for coupling to a load carrier;

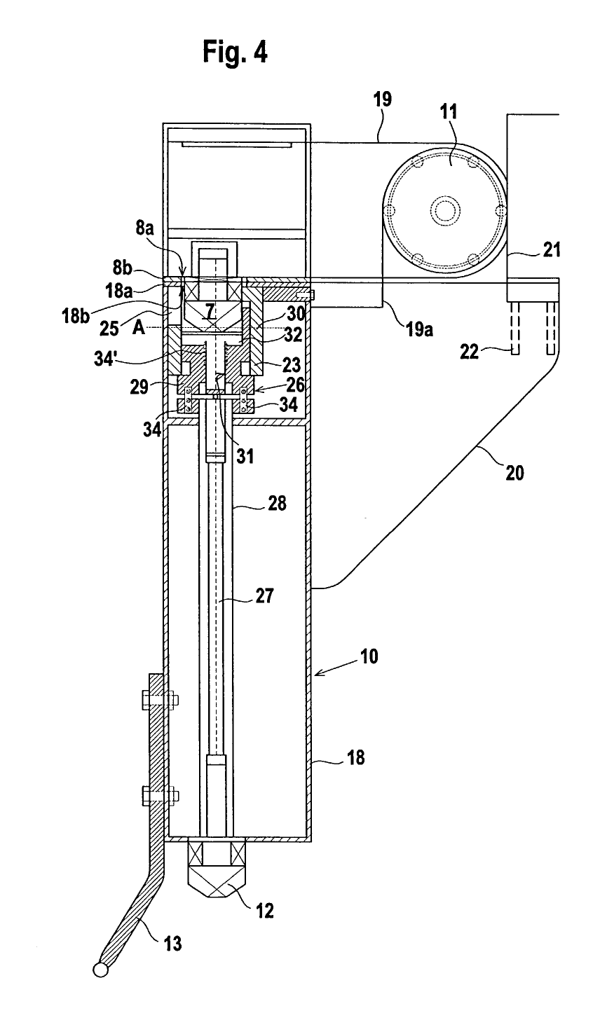

FIG. 4: a longitudinal section through a stilt leg; and

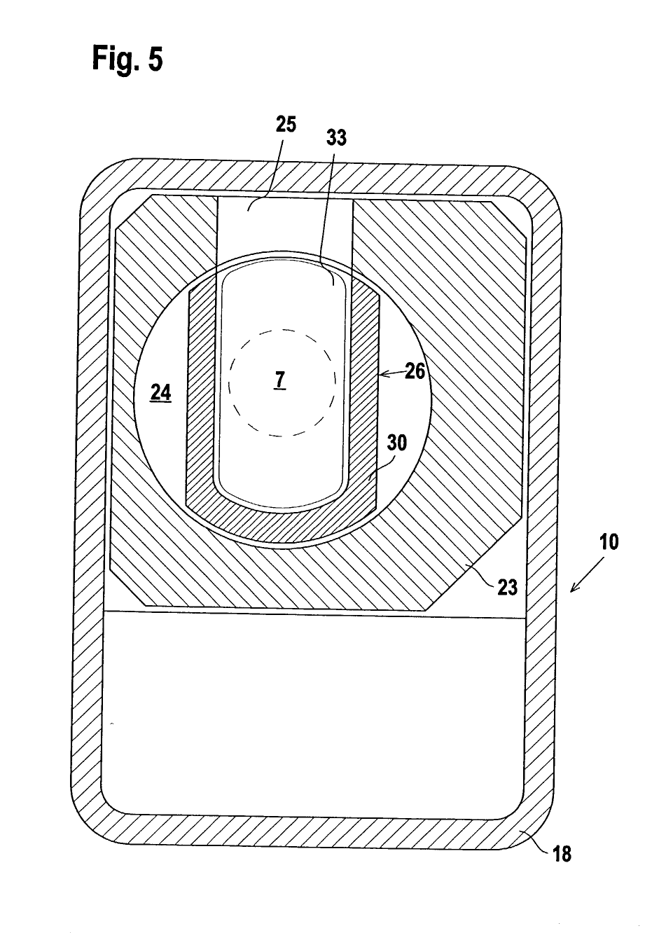

FIG. 5: a cross-section through the stilt leg according to FIG. 4, along the line represented by A.

### FIG. 1 illustrates an embodiment of a lifting apparatus 1 for transporting a load carrier, not shown.

The lifting apparatus 1 has a main frame 2, in which two sliding carriers 3 are guided. The main frame 2 comprises steel, and has an essentially parallelepiped outer contour. Openings, into which the sliding carriers 3 are inserted, are provided at the long-side ends of the main frame 2. The sliding carriers 3 are disposed so as to be displaced in the longitudinal direction of the main frame 2, ending at opposite long-side ends of the main frame 2.

The sliding carriers 3 comprise steel, glass fibers or carbon-fiber composite materials, and are virtually identical in design. Each sliding carrier 3 has two beams 4, which extend in the longitudinal direction of the carrier. The beams 4 extend parallel to one another with spacing, and have a rectangular cross-section.

As can be seen from FIG. 2, the heights of the beams 4 essentially correspond to the height of the main frame 2.

A connecting rod 5, which is likewise a component of the respective sliding carrier 3, extends between and parallel to the beams 4.

As can be seen from FIG. 1, the beams 4 of the first sliding carrier 3 are laterally offset relative to the beams 4 of the second sliding carrier 3, so the beams can slide past one another inside the main frame 2. Drives, not shown, are provided for executing the sliding movements of the sliding carriers 3.

A head piece 6 is disposed at each free long-side end of the sliding carriers 3; the beams 4 and the connecting rod 5 of the sliding carrier 3 are all guided to the head piece 6. The longitudinal axis of the head piece 6 extends transversely to the longitudinal axis of the corresponding sliding carrier 3. Receptacles for coupling to a load carrier are provided at the ends of the head piece 6, and protrude laterally past the sliding carrier 3.

The receptacles are formed by a twist lock 7. A twist lock 7 of this type is disposed in a housing element 8 at each end of a head piece 6.

Corner guides 9 are provided as further receptacles on the head piece 6. Each corner guide 9 is associated with a twist lock 7.

The twist locks 7 and the corner guides 9 disposed on the head pieces 6 serve in coupling load carriers that are designed to allow the receptacles to be positioned on the top side of the load carrier. These load carriers are particularly formed by containers. The lifting device 1 is placed, with the sliding carriers 3, onto the top side of the container. The corner guides 9 serve in positioning the lifting apparatus 1 such that the twist locks 7 extend into recesses on the top side of the container. The twist locks 7 are driven by drives, thereby being set into a rotational movement and fixed in the receptacles. Afterward, the lifting apparatus 1 can lift and transport the container.

With the lifting apparatus 1 according to the invention, load carriers carrying loads that extend past the top side of the load carrier can also be transported without separate, additional parts, such as oversized frames.

For this purpose, stilt legs 10 are seated to pivot on the sliding carriers 3. As can be seen from FIGS. 1 and 2, a stilt leg 10 is disposed at each long-side end of the head pieces 6. A stilt leg 10 is directly associated with each twist lock 7 on a respective sliding carrier 3.

The stilt legs 10 are identical in construction. Each stilt leg 10 is seated to pivot about a horizontal axis; a drive is provided for executing the pivoting movement. The drive adjoins the upper end of the stilt leg 10, and is disposed in the pivoting axis. The drive can be formed by a hydraulic drive. In the present example, the drive comprises an electric motor 11.

Twist locks 12 and corner guides 13 are provided, as receptacles for coupling to a load carrier, at the lower ends of the stilt legs 10; the corner guides are preferably identical in design to the receptacles on the sliding carriers 3.

The stilt legs 10 can pivot between a first and a second end position by an angle α, the angle α being in a range of 90°≦α≦100°. In the present example, the angle α=100°.

FIGS. 1 and 2 show the stilt legs 10 in their first end positions. Each stilt leg 10 extends essentially parallel to the sliding carriers 3; the longitudinal axes of the stilt legs 10 extend at an angle of about 100 relative to the horizontal.

In the first end positions, the stilt legs 10 are disposed such that the undersides of the sliding carriers 3, and especially the receptacles disposed on them for coupling to a container, are exposed.

FIG. 3 shows the stilt legs 10 in their second end positions. In this case, the stilt legs 10 extend vertically, and project at a right angle from the undersides of the sliding carriers 3.

Coupling to a load carrier is effected when the receptacles of the stilt legs 10 are in the second end positions; in FIG. 3, the carrier is represented as a flat 14.

The flat 14 has a base 15 with a level support surface and a rectangular cross-section. Furthermore, the flat 14 has four identical profiles 16, which are disposed at the corners of the base 15 and extend upward at a right angle from the support surface.

The load to be transported is an oversized machine part 17 disposed on the support surface and protruding past the upper edges of the profiles 16. Thus, it is not possible to position the sliding carriers 3 of the lifting apparatus 1 directly onto the profiles 16 of the flat 14.

Therefore, for coupling the lifting apparatus 1, the stilt legs 10 located in the second end positions are placed onto the profiles 16. The corner guides 13 serve in positioning the stilt legs 10. When the stilt legs 10 are positioned, the twist locks 12 disposed on their undersides extend into recesses of the profiles 16, not shown. Rotating the twist locks 12 secures the locks in the recesses. The lifting apparatus 1 can therefore lift and transport the flat 14.

In principle, the corner guides 13 and the twist locks 12 of the stilt legs 10 can be driven separately, so the corner guides 13 can be pivoted suitably and the twist locks 12 can be set into a rotational movement.

FIGS. 4 and 5 illustrate an embodiment of a stilt leg 10, in which no separate drive is provided for these receptacles. The stilt leg 10 has a housing 18 in the form of a hollow profile. The housing 18, and preferably further components of the stilt leg 10, are made of steel, glass fiber or a carbon-fiber composite material.

The corner guide 13 of the stilt leg 10 is rigidly connected to the housing 18. In the present case, the corner guide 13 is fixedly screwed to the housing 18. In principle, a plurality of corner guides 13 can also be secured to the stilt leg 10.

FIG. 4 shows the stilt leg 10 in its second end position. In this second end position, the longitudinal axis of the housing 18 of the stilt leg 10 extends vertically. A horizontal pivoting arm 19 adjoins the top side 18a of the housing 18. The electric motor 11 is housed in this pivoting arm 19; the longitudinal axis of the electric motor 11 coincides with the pivoting axis about which the pivoting movement is effected.

The pivoting arm 19 has a strut 19a in the form of a sheet-steel component. The strut is secured to the upper end of the housing 18, and thus holds the housing 18 more securely to the pivoting arm 19.

A sheet-steel corner plate 20, which is secured to a pivoting part 21 that rotates with the pivoting arm 19, is further fixed to the housing 18. A securing part 22 that functions as a stop to limit the pivoting movement is disposed at the upper end of the sheet-steel corner plate 20.

The upper portion of the housing 18 of the stilt leg 10 forms an adapter head, which serves in coupling the stilt leg 10 to the twist lock 7 on the head piece 6.

The front end of the twist lock 7, whose longitudinal axis extends vertically, projects through a bore 8a in the housing floor 8b of the housing element 8 on the head piece 6. In the second end position of the stilt leg 10, the top side 18a of the housing 18 rests on the housing floor 8b of the housing element 8; the top side 18a of the housing 18 is provided with a bore 18b that is aligned with the bore 8a of the housing floor 8b.

A guide 23 adjoins the top side 18a of the housing 18, and is rigidly connected to the housing 18 of the stilt leg 10.

The guide 23 has a central bore 24, which has a circular cross-section. A recess 25 is provided in the upper region of the side of the guide 23 that faces away from the electric motor 11. The width of the recess 25 is adapted to the dimensions of the twist lock 7 projecting past the upper end of the guide 23 and into the bore 24.

A carrier claw 26 projects past the lower end of the guide 23 and into the bore 24. The carrier claw 26 is seated on the upper end of a drive rod 27, and is permanently connected thereto. The drive rod 27 is guided in a guide tube 28. The twist lock 12 of the stilt leg 10 projecting past the lower end of the housing 18 adjoins the lower end of the drive rod 27 extending in the longitudinal direction of the housing 18. The longitudinal axis of the twist lock 12 of the stilt leg 10 extends coaxially to the longitudinal axis of the drive rod 27 rigidly connected to the lock. Moreover, in the second end position of the stilt leg 10, the drive rod 27 extends coaxially to the longitudinal axis of the twist lock 7 on the head piece 6.

The carrier claw 26 has a rotationally symmetrical base 29, and a guide element 30 that protrudes from the top side of the base. The upper portion of the base, and the guide element 30, extend into the bore 24 of the guide 23. The diameter of the base 29 is adapted to the inner diameter of the guide 23, so the jacket surface of the base rests tightly against the inner wall of the guide 23. The outer jacket surface of the guide element 30 also rests against the inner wall of the guide 23.

The base 29 has a central bore 31, in which the upper end of the drive rod 27 extends.

A cap 32 that rests against the top side of the base 29 adjoins the upper end of the drive rod 27. In the end position of the stilt leg 10 shown in FIG. 4, the top side of the cap 32 rests against the lower edge of the twist lock 7.

The carrier claw 26 has a central recess that is adapted to the outer contour of the twist lock 7. Hence, the inside of the carrier claw 26 rests tightly against a segment of the twist lock 7 in the second end position of the stilt leg 10. As can be seen in FIG. 5, the carrier claw 26 has a lateral recess 33, which is adapted to the recess 25 of the guide 23.

A spring 34 prestresses the carrier claw 26. The spring force acting in the longitudinal direction of the drive rod 27 presses the carrier claw 26, with a prestress, against the drive rod 27.

A spring 34′ is provided between the carrier claw 26 and the cap 32.

The carrier claw 26 surrounds the twist lock 7 of the head piece 6 on three sides. This coupling causes the carrier claw 26 to rotate when the twist lock 7 rotates about its longitudinal axis. The drive rod 27 transmits the rotational movement of the carrier claw 26 to the twist lock 12 at the lower end of the stilt leg 10.

The carrier claw 26 and the drive rod 27 therefore form a coupling device that transmits the rotational movement of the twist lock 7 of the sliding carrier 3 to the twist lock 12 of the stilt leg 10 when the leg is located in its second end position. Here, the spring 34 reliably assures the coupling of the coupling device to the twist lock 7 of the sliding carrier 3.

The coupling device is automatically coupled to the twist lock 7 of the sliding carrier 3 when the stilt leg 10 pivots into the second end position. The arrangement and the geometric embodiment of the carrier claw 26 allow it to be guided to the twist lock 7 during the pivoting movement of the stilt leg 10. The recess 33 on the carrier claw 26, and the recess 25 on the guide 23, prevent the carrier claw 26 from tilting at the twist lock 7.

Likewise, when the stilt leg 10 pivots into the first pivot position, the carrier claw 26 is automatically released from the twist lock 7 without tilting.

List of Reference Characters

(1) Lifting apparatus

(2) Main frame

(3) Sliding carrier

(4) Beams

(5) Connecting rod

(6) Head piece

(7) Twist lock on head piece

(8) Housing element

(8a) Bore

(8b) Housing floor

(9) Corner guides on head piece

(10) Stilt legs

(11) Electric motor

(12) Twist lock on stilt legs

(13) Corner guides on stilt legs

(14) Flat

(15) Base

(16) Profiles

(17) Machine part

(18) Housing

(18a) Top of housing

(18b) Bore

(19) Pivoting arm

(19a) Strut

(20) Sheet-steal corner plate

(21) Pivoting part

(22) Securing element

(23) Guide

(24) Bore

(25) Recess

(26) Carrier claw

(27) Drive rod

(28) Guide tube

(29) Base

(30) Guide element

(31) Bore

(32) Cap

(33) Recess

(34) Spring

(34′) Spring

1. A lifting apparatus for transporting a load carrier, having a main frame and two sliding carriers, with a sliding carrier being seated so as to be displaced in the longitudinal direction of the main frame, ending at each long-side end of the main frame, and with the sliding carriers being provided at their free long-side ends with receptacles for coupling to the load carrier, characterized in that stilt legs (10) are seated to pivot on the sliding carriers (3), each being able to pivot into a first end position, in which the receptacles on the sliding carriers (3) for coupling to a load carrier are exposed, the stilt legs (10) also being able to pivot into a second end position, in which they project from the undersides of the sliding carriers (3), so the stilt legs (10) can be coupled to a load carrier by receptacles provided at their free ends.

2. The lifting apparatus according to claim 1, characterized in that four identical stilt legs (10) are seated to pivot at the free long-side ends of the sliding carriers (3).

3. The lifting apparatus according to claim 2, characterized in that a separate drive is provided for executing the pivoting movement of each stilt leg (10).

4. The lifting apparatus according to claim 3, characterized in that the drive lies in the pivoting axis of the respective stilt leg (10).

5. The lifting apparatus according to claim 3 or 4, characterized in that the drive is embodied as a hydraulic drive or an electric motor (11).

6. The lifting apparatus according to one of claims 1 through 5, characterized in that the longitudinal axes of the stilt legs (10) extend essentially parallel to the horizontal longitudinal axes of the sliding carriers (3) when the legs are in their first end positions.

7. The lifting apparatus according to one of claims 1 through 6, characterized in that the longitudinal axes of the stilt legs (10) extend vertically in their second end positions.

8. The lifting apparatus according to one of claims 1 through 7, characterized in that the stilt legs (10) can pivot by an angle a, with the angle a being in a range of 90°≦α≦100°.

9. The lifting apparatus according to one of claims 1 through 8, characterized in that a head piece (6) is provided at each free long-side end of the sliding carrier (3), the longitudinal axis of the head piece extending transversely to the longitudinal axis of the sliding carriers (3), and a stilt leg (10) is disposed at the long-side ends of the head pieces (6) that project laterally beyond the sliding carriers (3).

10. The lifting apparatus according to one of claims 1 through 9, characterized in that a rotating twist lock (12) is provided as a receptacle at each free end of the stilt legs (10).

11. The lifting apparatus according to claim 10, characterized in that driven, rotating twist locks (7) are provided as receptacles on the sliding carriers (3), with a twist lock (7) having an associated stilt leg (10), so in the second end position of the leg, a coupling device transmits the rotational movement of a twist lock (7) to the twist lock (12) of the associated stilt leg (10).

12. The lifting apparatus according to claim 11, characterized in that the coupling device has a carrier claw (26) and a drive rod (27) that is connected to the claw and extends in the longitudinal direction of a stilt leg (10); in the second end position of the stilt leg (10), the carrier claw (26) is coupled to the respective associated twist lock (7) of the sliding carrier (3) such that the carrier claw (26) rotates with the twist lock, and the drive rod (27) transmits the rotation of the carrier claw (26) to the twist lock (12) of the stilt leg (10).

13. The lifting apparatus according to claim 12, characterized in that the twist lock (12) of a stilt leg (10) adjoins the lower end of the drive rod (27) coaxially to the rod.

14. The lifting apparatus according to claim 12 or 13, characterized in that, in the second end position of a stilt leg (10), its drive rod (27) is disposed so as to be coaxial to the associated twist lock (7) of the sliding carrier (3).

15. The lifting apparatus according to one of claims 12 through 14, characterized in that, in the second end position of a stilt leg (10), a spring (34) prestresses the carrier claw (26) of the leg.

16. The lifting apparatus according to one of claims 12 through 15, characterized in that the carrier claw (26) of a stilt leg (10) has a base (29) that is seated on the drive rod (27), and a guide element (30) that protrudes from the base (29), with the guide element (30) resting laterally, in a form-fit, against a segment of the twist lock (7) of the sliding carrier (3) in the second end position of the stilt leg (10).

17. The lifting apparatus according to one of claims 12 through 15, characterized in that the carrier claw (26) is guided in a guide (23), which is provided with a circular-cylindrical bore (24), against the inner wall of which the jacket surface of a segment of the carrier claw (26) rests.

18. The lifting apparatus according to claim 17, characterized in that each stilt leg (10) has a hollow profile that forms a housing (18), with the guide (23) being rigidly connected to the profile.

19. The lifting apparatus according to claim 18, characterized in that at least one corner guide (13) that forms a further receptacle is provided at the lower end of the housing (18) of a stilt leg (10).

20. The lifting apparatus according to claim 19, characterized in that the corner guide (13) is rigidly connected to the housing (18).

21. The lifting apparatus according to claim 19, characterized in that the corner guide (13) is driven by a drive and is seated to pivot on the housing (18).

22. The lifting apparatus according to one of claims 1 through 21, characterized in that the stilt legs (10) comprise steel, glass fiber and/or carbon-fiber composite material.

23. The lifting apparatus according to one of claims 1 through 22, characterized in that the sliding carriers (3) comprise steel, glass fiber and/or carbon-fiber composite materials.
